(19) United States
(12) Patent Application Publication
(10) Pub. No.: US 2008/0204597 A1
(43) Pub. Date: Aug. 28, 2008

(54) METHOD AND APPARATUS FOR REPRODUCING MOVING PICTURE DATA HAVING SUB-SCREEN PICTURE DATA

(75) Inventor: Kyung-hoon KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/855,438

(22) Filed: Sep. 14, 2007

(30) Foreign Application Priority Data
Feb. 23, 2007 (KR) 10-2007-0018514

(51) Int. Cl. H04N 5/445

(52) U.S. Cl. 348/564; 348/E05.099

(57) ABSTRACT

Provided are a method and apparatus for reproducing moving picture data which includes sub-screen picture data. The method includes outputting messages indicating that the moving picture data includes the sub-screen picture data, receiving a selection on whether to display the sub-screen picture data, and selectively displaying the sub-screen picture data according to the selection. Accordingly, the sub-screen picture data can be selectively displayed.

### CROSS-REFERENCE TO RELATED PATENT APPLICATION

This application claims priority from Korean Patent Application No. 10-2007-0018514 filed on Feb. 23, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to reproducing moving picture data, and more particularly, to reproducing moving picture data having sub-screen picture data.

2. Description of the Related Art

A recent functional trend of devices reproducing moving picture data, recorded in storage mediums such as digital versatile discs (DVDs), Blu-ray disks, high definition (HD)-DVDs, etc., is to provide a picture in picture (PIP) function which shows two different moving picture data on one screen. Here, the PIP function is a display function where two images are displayed on one screen, which receives input moving picture data having main screen picture data and sub-screen picture data and displays a main screen picture 110 in a full screen size and a sub-screen picture 120 in a smaller size in an inset fashion as illustrated in FIG. 1.

A reason for inserting a sub-screen picture in a moving picture title is to deliver additional information to a certain part of the moving picture, or to provide an advertisement using the sub-screen picture. However, inserting a sub-screen picture while viewing a main screen picture may make it difficult for a user to understand a context of the main screen picture, or cause discontinuity in tracking a flow of the context of the main screen picture.

Therefore, users may or may not want the sub-screen picture to be displayed while the moving picture data is reproduced, depending on their preferences. On the other hand, the users may feel that, for some images, having a sub-screen picture may not cause any problem in viewing, and for other images, having the sub-screen picture may distract from viewing. Therefore, a method and apparatus for reproducing moving picture data where the user can select whether a sub-screen picture is to be displayed are required.

### SUMMARY OF THE INVENTION

The present invention provides a method of reproducing moving picture data where a sub-screen picture is displayed according to a selection.

The present invention also provides an apparatus for reproducing the moving picture data where the sub-screen picture is displayed according to the selection.

The present invention also provides a computer readable recording medium having recorded thereon a program for executing the above method.

According to an aspect of the present invention, there is provided a method of reproducing moving picture data which includes sub-screen picture data, the method including: outputting a message indicating that the moving picture data includes the sub-screen picture data; receiving a selection on whether to display the sub-screen picture data; and selectively displaying the sub-screen picture data according to the selection.

In the outputting the message operation, the message may be output a predetermined time before the displaying of the sub-screen picture data while the moving picture data is being reproduced, and the message may be displayed on a screen in which the moving picture data is being displayed.

The moving picture data may further include information on a time when the sub-screen picture data is to be displayed.

The method of reproducing the moving picture data includes setting up a mode for displaying the sub screen picture data which comprises receiving a mode selection indicating a mode selected from among a first mode for displaying the sub-screen picture data, a second mode for not displaying the sub-screen picture data, and a third mode for selectively displaying the sub-screen picture data, wherein the outputting the message, receiving the selection, and selectively displaying the sub-screen picture data are performed only if the mode selection indicates the third mode is selected.

In the selectively displaying the sub-screen picture data operation, the sub-screen picture data is not displayed if the selection does not indicate to display the sub-screen picture data.

In the selectively displaying the sub-screen picture data operation, the sub-screen picture data is displayed if the selection indicates to display the sub-screen picture data.

According to another aspect of the present invention, there is provided an apparatus for reproducing the moving picture data which includes sub-screen picture data, the apparatus including: a message output unit which outputs a message indicating that the moving picture data contains the sub-screen picture data; a user interface which receives a selection on whether to display the sub-screen picture data; a moving picture data processor which processes the moving picture data; and a controller which controls the moving picture data processor in order to selectively display the sub-screen picture data according to the selection.

The message output unit may output the message a predetermined time before the sub-screen picture data is displayed while the moving picture data is being reproduced.

The message output unit may output the message on the screen in which the moving picture data is being displayed.

The moving picture data may further include information on a time when the sub-screen picture data is to be displayed.

The user interface as a mode set for displaying the sub screen picture data receives a mode selection indicating a mode selected from among the first mode for displaying the sub-screen picture data, the second mode for not displaying the sub-screen picture data, and the third mode for selectively displaying the sub-screen picture, wherein the message output unit may output the message only if the mode selection indicates the third mode is selected.

The controller may control the processor to not output the sub-screen picture data for display if the selection received by the user interface does not require the sub-screen picture data to be displayed and to output the sub-screen picture data for display if the selection is not received by the user interface.

The controller may control the processor to output the sub-screen picture data for display if the selection received by the user interface requires the sub-screen picture data to be displayed and to not output the sub-screen picture data for display if the selection is not received by the user interface.

The moving picture data processor including: a data separator which separates the moving picture data into main screen picture data and the sub-screen picture data; a first decoder which outputs a main screen picture signal by decoding the main screen picture data; a second decoder which outputs a sub-screen picture signal by decoding the sub-screen picture data; and a picture signal compositor which combines the main screen picture signal and the sub-screen picture signal, to be output, wherein the controller controls the picture signal compositor to selectively combine the sub-screen picture signal and the main screen picture signal to be output according to the selection.

According to another aspect of the present invention, there is provided a computer readable recording medium having recorded thereon a program for executing the above described method including: outputting the message indicating that the moving picture data includes the sub-screen picture data; receiving the selection on whether to display the sub-screen picture data; and selectively displaying the sub-screen picture data according to the selection which is received.

### BRIEF DESCRIPTION OF THE DRAWINGS

The above and other aspects of the present invention will become more apparent by describing in detail exemplary embodiments thereof with reference to the attached drawings in which:

FIG. 1 illustrates how a main screen picture and a sub-screen picture are displayed in a PIP function;

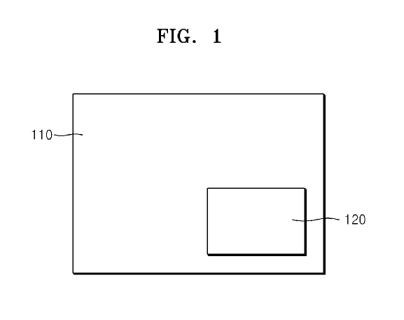

FIG. 2 is a block diagram of an apparatus reproducing moving picture data according to an exemplary embodiment of the present invention;

FIG. 3 illustrates an exemplary embodiment of a data format of moving picture data having main screen picture data and sub-screen picture data;

FIG. 4 is a flowchart of a moving picture reproducing method according to an exemplary embodiment of the present invention; and

FIG. 5 is a flowchart explaining an operation of selectively displaying sub-screen picture data of the moving picture reproducing method illustrated in FIG. 4 in detail.

### DETAILED DESCRIPTION OF EXEMPLARY EMBODIMENTS OF THE INVENTION

Hereinafter, exemplary embodiments of the present invention will be described in detail with reference to the appended drawings.

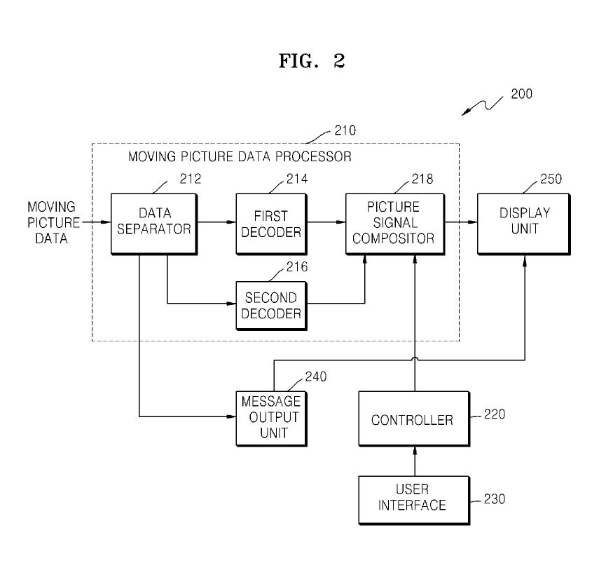

FIG. 2 is a block diagram of an apparatus reproducing moving picture data according to an exemplary embodiment of the present invention. Referring to FIG. 2, an apparatus reproducing the moving picture data 200 according to the current exemplary embodiment includes a moving picture data processor 210, a controller 220, a user interface 230, a message output unit 240, and a display unit 250.

The moving picture data processor 210 receives the moving picture data, processes the moving picture data into a displayable picture signal, and outputs the displayable picture signal to the display unit 250. In particular, if the moving picture data includes main screen picture data and sub-screen picture data, the moving picture data processor 210 only outputs the picture signal corresponding to the main screen picture data or a picture signal composed of a signal corresponding to the main screen picture data and a signal corresponding to the sub-screen picture data.

Specifically, the moving picture data processor 210 includes a data separator 212, a first decoder 214, a second decoder 216, and a picture signal compositor 218.

The data separator 212 receives the moving picture data which includes the main screen picture data and the sub-screen picture data.

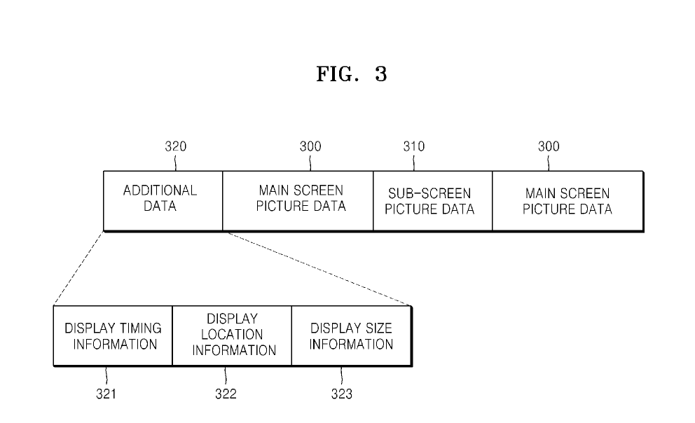

FIG. 3 illustrates the data format of moving picture data having main screen picture data 300 and sub-screen picture data 310, according to an exemplary embodiment of the present invention.

Referring to FIG. 3, the moving picture data includes the main screen picture data 300, the sub-screen picture data 310, and additional data 320. At least one of the main screen picture data 300 and the sub-screen picture data 310 may have identification information (not shown) in order to identify one from the other when separating. The additional data 320 includes information about a display type of the sub-screen picture, such as display timing information 321 indicating timing and a period of the sub-screen picture display while the main screen picture is being played, display location information 322 indicating a location of the sub-screen picture displayed within the main screen picture, and display size information 323 indicating the size of the sub-screen picture displayed within the main screen picture.

The data separator 212 separates input moving picture data into the main screen picture data 300, the sub-screen picture data 310, and the additional data 320, outputs the main screen picture data 300 to the first decoder 214, and outputs the sub-screen picture data 310 and the additional data 320 to the second decoder 216. Also, the data separator 212 outputs the display timing information 321 of the additional data 320 to the message output unit 240.

The first decoder 214 outputs a main screen picture signal to the picture signal compositor 218 by decoding the main screen picture data 300 received from the data separator 212.

The second decoder 216 outputs the sub-screen picture signal to the picture signal compositor 218 by decoding the sub-screen picture data 310 received from the data separator 212. At this time, the second decoder 216 outputs the sub-screen picture signal, according to the display type of the sub-screen picture being displayed, which is determined in the additional data 320.

The picture signal compositor 218 either outputs the main screen picture signal and the sub-screen picture signal output from each respective decoder, such as the first decoder 214 and the second decoder 216, by combining them, or only outputs the main screen picture signal output from the first decoder 214 to the display unit 250, according to a control signal output from the controller 220.

The display unit 250 displays the picture signal output from the picture signal compositor 218.

The user interface 230 receives a display mode selection for the sub-screen picture data from the user. The mode includes a first mode which always displays the sub-screen picture data, a second mode which never displays the sub-screen picture data, and a third mode which selectively displays the sub-screen picture data according to the user's selection while the moving picture is being displayed.

When the display mode of the sub-screen picture data is set to the first mode, the controller 220 outputs a control signal which controls the picture signal compositor 218 to combine and output the main screen picture signal and the sub-screen picture signal.

When the display mode of the sub-screen picture data is set to the second mode, the controller 220 outputs a control signal which controls the picture signal compositor 218 to only output the main screen picture signal.

When the display mode of the sub-screen picture data is set to the third mode, the controller 220 outputs a control signal which controls the picture signal compositor 218 either to combine and output the main screen picture signal and the sub-screen picture signal or to only output the main screen picture signal, according to the selection made by the user.

An operation of setting the display mode of the sub-screen picture data to the third mode will now be explained in detail.

When the display mode of the sub-screen picture data is set to the third mode, the message output unit 240 outputs a message notifying that the sub-screen picture data is included in the moving picture data a predetermined time before the sub-screen picture data will be displayed, while the moving picture is being displayed, on the basis of the display timing information 321 received from the data separator 212, in order to allow the user to determine that the sub-screen picture data is included within the moving picture data. For example, the message output unit 240 outputs a message, such as “PIP image included” or “PIP image will appear in 20 seconds” few seconds or several tens of seconds before the sub-screen picture data is displayed. The message notifying that the sub-screen picture is included may be displayed on the display unit 250 using an on-screen display (OSD) method.

The user interface 230 includes a unit for receiving a selection on whether to display the sub-screen picture data from the user. The user can enter the selection on whether to display the sub-screen picture data by using the user interface 230 after receiving the message notifying that the sub-screen picture data is included. When the selection is made to display the sub-screen picture data by the user, the controller 220 controls the picture signal compositor 218 to output the picture signal composed of the main screen picture signal and the sub-screen picture signal. When the selection is made not to display the sub-screen picture data by the user, the controller 220 controls the picture signal compositor 218 to only output the main screen picture signal. However, when the picture signal compositor 218 did not receive the control signal from the controller 220, either composition of the main screen picture signal and the sub-screen picture signal is output or the main screen picture signal is output according to a set default value, because the selection may not have been made even though the user already determined that the sub-screen picture is included after reading the notification message. The default value may be set in an original set up in the apparatus reproducing the moving picture data 200 or may be set by the user by using the user interface 230.

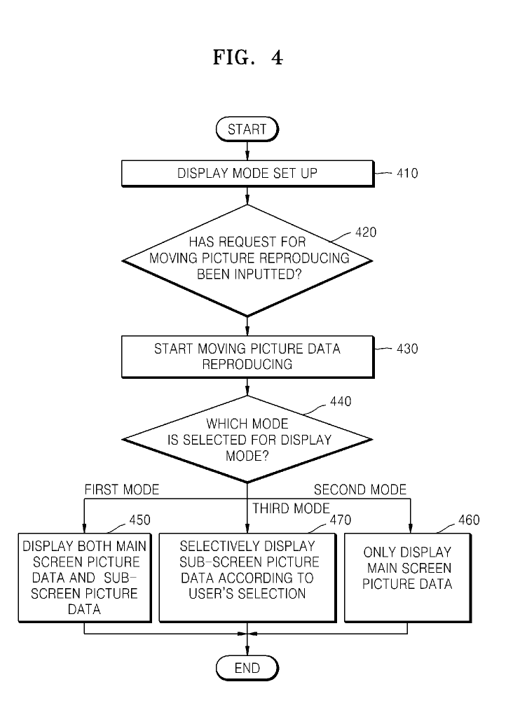

FIG. 4 is a flowchart of a moving picture reproducing method according to an exemplary embodiment of the present invention.

The moving picture reproducing method according to an exemplary embodiment of the present invention is constituted of operations sequentially processed in the moving picture data reproducing apparatus 200 illustrated in FIG. 2. Accordingly, although not described here, the operations of the apparatus reproducing the moving picture data 200 illustrated in FIG. 2 can also be applied to the method of reproducing moving picture data according to an exemplary embodiment of the present invention.

Firstly, the apparatus reproducing the moving picture data 200 receives a display mode selection for the sub-screen picture data from the user (410). The mode includes a first mode which always displays the sub-screen picture data, a second mode which never displays the sub-screen picture data, and a third mode which selectively displays the sub-screen picture data according to the user's selection while the moving picture is being reproduced.

When a request for reproducing the moving picture data is input by the user in operation 420, the apparatus reproducing the moving picture data 200 receives the moving picture data and starts reproducing the moving picture data in operation 430.

In operation 440, the apparatus reproducing the moving picture data 200 checks the display mode set for the sub-screen picture data.

If the first mode is set, the apparatus reproducing the moving picture data 200 displays both the main screen picture data and the sub-screen picture data, in operation 450.

If the second mode is set, the apparatus reproducing the moving picture data 200 only displays the main screen picture data without displaying the sub-screen picture data, in operation 460.

If the third mode is set, the apparatus reproducing the moving picture data 200 selectively displays the sub-screen picture data according to the user's selection. In other words, the apparatus reproducing the moving picture data 200 either displays both the main screen picture data and the sub-screen picture data or the main screen picture data only, according to the user's selection, in operation 470.

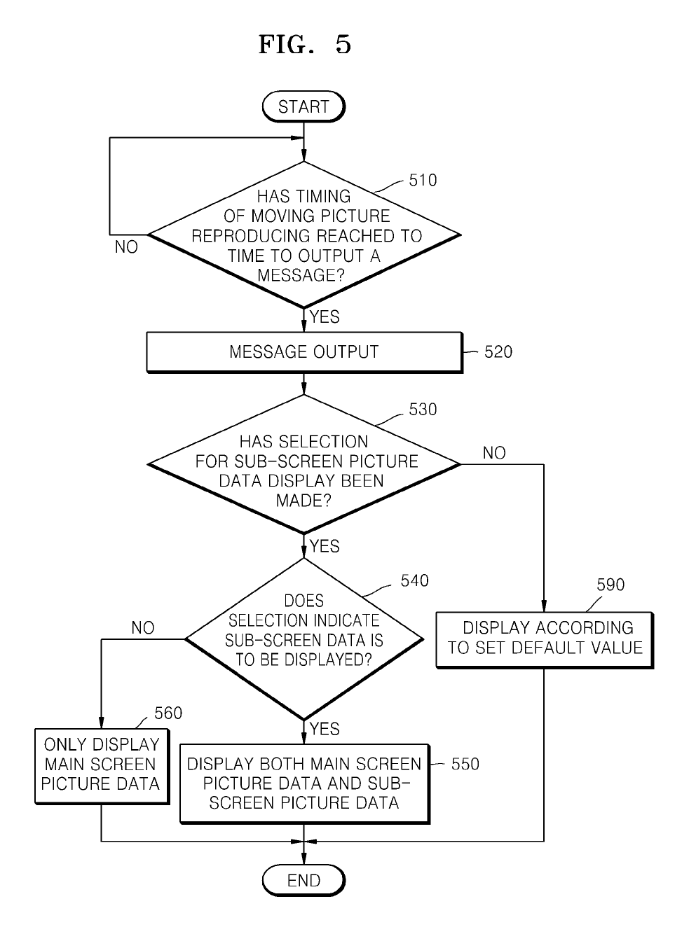

FIG. 5 is a flowchart explaining operation 470 of the moving picture reproducing method illustrated in FIG. 4 in detail.

In operation 510, when timing of the moving picture reproducing reaches a predetermined time, that is a time to output a message, prior to when the sub-screen picture data is displayed, operation 520 is performed and the apparatus reproducing the moving picture data 200 outputs the message indicating that the sub-screen picture data is included.

In operation 530, it is determined whether a selection to display the sub-screen picture data is made by the user.

If it is determined that the selection is made to display the sub-screen picture data in operation 530, it is then determined whether the selection indicates the sub-screen data is to be displayed in operation 540. If it is determined that the selection indicates the sub-screen data is to be displayed in operation 540, the apparatus reproducing the moving picture data 200 displays both the main screen picture data and the sub-screen picture data, in operation 550. If it is determined that the selection indicates the sub-screen picture data is not to be displayed in operation 540, the apparatus reproducing the moving picture data 200 only displays the main screen picture data without displaying the sub-screen picture data, in operation 560.

In operation 530, if the selection is not made until the time when the sub-screen picture data is displayed, operation 590 is then performed and either both the main screen picture data and the sub-screen picture data are displayed or only the main screen picture data is displayed, according to the set default value.

As described above, the exemplary embodiments of the present invention may be written as a program which is run on a computer, and may be embodied on a common digital computer which runs the program using a computer readable recording medium. Also, a structure of the data used in the exemplary embodiments of the present invention may be recorded in the computer readable recording medium in various ways.

Examples of the computer readable recording medium include magnetic storage media (e.g., ROM, floppy disks, hard disks, etc.), and optical recording media (e.g., CD-ROMs, or DVDs).

According to an aspect of the present invention, a sub-screen picture can be selectively displayed according to the user's selection, wherein a message for the user to determine that the sub-screen picture data is included is output and the user then has flexibility in selecting whether to watch the sub-screen picture data by selectively displaying a sub-screen picture data according to the selection received from the user.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of reproducing moving picture data which includes sub-screen picture data, the method comprising:
outputting a message indicating that the moving picture data includes the sub-screen picture data;
receiving a selection on whether to display the sub-screen picture data; and
selectively displaying the sub-screen picture data according to the selection which is received.

2. The method of claim 1, wherein in the outputting the message, the message is output a predetermined time before the displaying of the sub-screen picture data while the moving picture data is being reproduced.

3. The method of claim 1, wherein in the outputting the message, the message is displayed on a screen in which the moving picture data is being displayed.

4. The method of claim 1, wherein the moving picture data further includes information on a time when the sub-screen picture data is to be displayed.

5. The method of claim 1, further comprising setting a mode for displaying the sub screen picture data, wherein the setting the mode comprises receiving a mode selection indicating a mode selected from among a first mode for displaying the sub-screen picture data, a second mode for not displaying the sub-screen picture data, and a third mode for selectively displaying the sub-screen picture data,
wherein the outputting the message, receiving the selection, and selectively displaying the sub-screen picture data are performed only if the mode selection indicates the third mode is selected.

6. The method of claim 1, wherein in the selectively displaying the sub-screen picture data, the sub-screen picture data is not displayed if the selection does not indicate to display the sub-screen picture data.

7. The method of claim 1, wherein in the selectively displaying the sub-screen picture data, the sub-screen picture data is displayed if the selection indicates to display the sub-screen picture data.

8. A computer readable storage medium having embodied thereon a computer program for reproducing moving picture data which includes sub-screen picture data, the program comprising:
outputting a message indicating that the moving picture data includes the sub-screen picture data,
receiving a selection on whether to display the sub-screen picture data, and
selectively displaying the sub-screen picture data according to the selection which is received.

9. An apparatus for reproducing moving picture data which includes sub-screen picture data, the apparatus comprising:
a message output unit which outputs a message indicating that the moving picture data includes the sub-screen picture data;
a user interface which receives a selection on whether to display the sub-screen picture data;
a moving picture data processor which processes the moving picture data; and
a controller which controls the moving picture data processor in order to selectively display the sub-screen picture data according to the selection.

10. The apparatus of claim 9, wherein the message output unit outputs the message a predetermined time before the sub-screen picture data is displayed while the moving picture data is being reproduced.

11. The apparatus of claim 9, wherein the message output unit outputs the message on a screen in which the moving picture data is being displayed.

12. The apparatus of claim 9, wherein the moving picture data further includes information on a time when the sub-screen picture data is to be displayed.

13. The apparatus of claim 9, wherein the user interface receives a mode selection indicating a mode selected from among a first mode for displaying the sub-screen picture data, a second mode for not displaying the sub-screen picture data, and a third mode for selectively displaying the sub-screen picture,
wherein the message output unit outputs the message only if the mode selection indicates the third mode is selected.

14. The apparatus of claim 9, wherein the controller controls the processor to not output the sub-screen picture data for display if the selection received by the user interface does not require the sub-screen picture data to be displayed and to output the sub-screen picture data for display if the selection is not received by the user interface.

15. The apparatus of claim 9, wherein the controller controls the processor to output the sub-screen picture data for display if the selection received by the user interface requires the sub-screen picture data to be displayed and to not output the sub-screen picture data if the selection is not received by the user interface.

16. The apparatus of claim 9, wherein the moving picture data processor comprises:
a data separator which separates the moving picture data into main screen picture data and the sub-screen picture data;
a first decoder which outputs a main screen picture signal by decoding the main screen picture data;
a second decoder which outputs a sub-screen picture signal by decoding the sub-screen picture data; and
a picture signal compositor which combines the main screen picture signal and the sub-screen picture signal, to be output,
wherein the controller controls the picture signal compositor to selectively combine the sub-screen picture signal and the main screen picture signal to be output according to the selection.
